(19) United States
(12) Patent Application Publication
(10) Pub. No.: US 2026/0139504 A1
(43) Pub. Date: May 21, 2026

(54) ANTI-BACKFLOW COMPONENT

(71) Applicant: NINGBO POOLSTAR POOL PRODUCTS CO.,LTD., NINGBO (CN)

(72) Inventor: Liang CHEN, NINGBO (CN)

(21) Appl. No.: 19/452,731

(22) Filed: Jan. 19, 2026

(30) Foreign Application Priority Data
Nov. 7, 2025 (CN) 202522374901.3

(51) Int. Cl. E04H 4/16

(52) U.S. Cl. CPC E04H 4/1654

(57) ABSTRACT

An anti-backflow component for a water surface cleaning device is provided. The water surface cleaning device includes a collection box. The anti-backflow component includes a main body, a fixing structure and a float. The fixing structure is made of a flexible material. A first end of the fixing structure is connected to a bottom end of the main body, a second end of the fixing structure is connected to the collection box, so as to fix the anti-backflow component relative to the collection box. The float is provided in the main body.

### CROSS-REFERENCE TO RELATED APPLICATIONS

This application claims the benefit of priority from Chinese Patent Application No. 202522374901.3, filed on November 7, 2025. The content of the aforementioned application, including any intervening amendments made thereto, is incorporated herein by reference in its entirety.

### TECHNICAL FIELD

This application relates to pool cleaning equipment, and more particularly to an anti-backflow component.

### BACKGROUND

A water surface cleaning device is designed to automatically collect floating debris and garbage from the water surface to a garbage collection box. However, the existing water surface cleaning devices struggle with the following deficiency. When they are out of operation, the garbage temporarily stored in the garbage collection box are prone to flowing back to the pool through an inlet channel under the action of buoyancy, resulting in secondary contamination and reduced cleaning efficiency.

### SUMMARY

In view of this, an object of the disclosure is to provide an anti-backflow component to prevent garbage stored in a collection box from escaping, thereby avoiding secondary pollution and improving cleaning efficiency.

Technical solutions of the present disclosure are described as follows.

An anti-backflow component for a water surface cleaning device, the water surface cleaning device comprising a collection box, and the anti-backflow component comprising: a main body; a fixing structure; and a float; wherein the fixing structure is made of a flexible material; a first end of the fixing structure is connected to a bottom end of the main body, and a second end of the fixing structure is connected to the collection box, so as to fix the anti-backflow component relative to the collection box; and the float is provided on the main body.

In some embodiments, a bottom surface of the collection box is provided with an insertion hole; the fixing structure comprises a first flange portion, a second flange portion and a connecting portion; the first flange portion is provided at the bottom end of the main body; the connecting portion is provided between the first flange portion and the second flange portion; the second flange portion is provided at a bottom end of the connecting portion; the first flange portion and the second flange portion are both configured to protrude with respect to the connecting portion; and the connecting portion is configured to be embedded within the insertion hole.

In some embodiments, the fixing structure further comprises a first extension portion; and a first end of the first extension portion is connected to the bottom end of the main body, and a second end of the first extension portion is connected to the first flange portion.

In some embodiments, the fixing structure further comprises a first guiding portion; the first guiding portion is provided at a bottom end of the second flange portion; and a width of the first guiding portion is configured to decrease from an end connected to the second flange portion to an end away from the second flange portion.

In some embodiments, the fixing structure further comprises a second extension portion; and the second extension portion is provided at a bottom end of the first guiding portion.

In some embodiments, a plurality of fixing structures are provided; and the plurality of fixing structures are arranged spaced apart at the bottom end of the main body.

Compared to the prior art, the present disclosure has the following beneficial effects.

Regarding the anti-backflow component provided herein, the fixing structure is made of a flexible material, the float is provided on the main body, and the anti-backflow component is arranged in the collection box through the fixing structure. When a water surface cleaning device is out of operation, the anti-backflow component is allowed to float in water under the buoyancy provided by the float, thereby preventing garbage from escaping from the collection box, avoiding secondary pollution, and improving cleaning efficiency. When the water surface cleaning device is in operation, by virtue of flexibility of the fixing structure, the anti-backflow component is forced to tilt under the action of water flow, such that debris and garbage are carried by water flow to enter the collection box. In summary, the anti-backflow component provided herein can not only guide water flow and debris to smoothly enter the collection box, but also prevent debris in the collection box from escaping.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural diagram of a water surface cleaning device according to an embodiment of the present disclosure;

FIG. 2 is another structural diagram of the water surface cleaning device according to an embodiment of the present disclosure;

FIG. 3 is a structural diagram a collection box and a roller brush assembly of the water surface cleaning device according to an embodiment of the present disclosure;

FIG. 4 structurally depicts the collection box of the water surface cleaning device according to an embodiment of the present disclosure;

FIG. 5 is a structural diagram of the collection box according to an embodiment of the present disclosure with a third side plate removed;

FIG. 6 is a partial structural diagram of the collection box according to an embodiment of the present disclosure;

FIG. 7 is a structural diagram of the third side plate according to an embodiment of the present disclosure;

FIG. 8 is a structural diagram of a housing according to an embodiment of the present disclosure;

FIG. 9 is a structural diagram of an anti-backflow component according to an embodiment of the present disclosure;

FIG. 10 is an enlarged view of portion “A” in FIG. 9;

FIG. 11 is a partial structural diagram of the anti-backflow component according to an embodiment of the present disclosure viewed from another perspective;

FIG. 12 is a structural diagram of a fixing structure of the anti-backflow component according to an embodiment of the present disclosure;

FIG. 13 is a bottom view of the water surface cleaning device according to an embodiment of the present disclosure; and

FIG. 14 is a perspective view of a collection bag according to an embodiment of the present disclosure.

In the figures: 1-housing; 11-accommodating cavity; 12-first opening; 13-snap hole; 14-slider; 15-sliding rail; 16-mounting cavity; 17-control cavity; 2-roller brush assembly; 21-roller brush; 22-driving part; 3-collection box; 31-box main body; 311-bottom plate; 312-first side plate; 313-second side plate; 314-third side plate; 315-rotating shaft; 316-semicircular opening; 317-avoidance notch; 318-insertion hole; 32-handle; 321-recess; 33-baffle; 34-first snap-fit portion; 341-connecting portion; 342-protruding portion; 35-second snap-fit portion; 36-first cavity; 37-chemical storage container; 4-anti-backflow component; 41-main body; 411-second cavity; 412-supporting portion; 42-second float; 43-fixing structure; 431-first flange portion; 432-second flange portion; 433-connecting portion; 434-groove; 435-first guiding portion; 436-first extension portion; 437-second extension portion; 5-collection bag; 51-bag body; 52-connecting assembly; 521-main frame; 522-third snap-fit portion; 523-engaging portion; 6-driving assembly; 61-propeller; 62-radar; 63-switch; 64-indicator light; 65-solar panel; 66-anti-grounding member; and 67-anti-collision roller.

The implementation, functional characteristics and advantages of the present disclosure will be further described in conjunction with the embodiments and accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) are used only for explaining the relative positional relationship or movement between the components in a particular attitude (as shown in the accompanying drawings), and the directional indications are correspondingly changed if the particular attitude is changed.

As used herein, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist and is not included within the scope of the present disclosure.

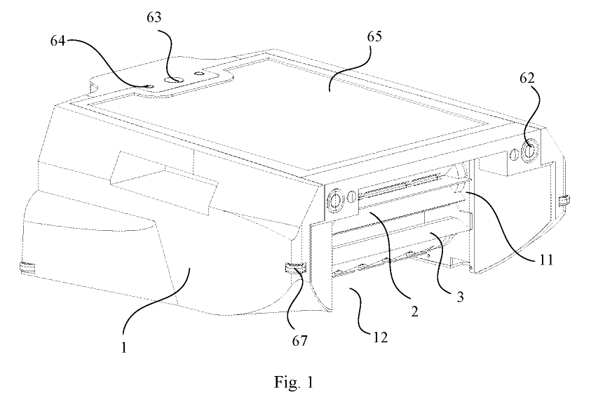

As shown in FIGS. 1-4, an embodiment of the present disclosure provides a water surface cleaning device. The water surface cleaning device includes a housing 1, a roller brush assembly 2, a collection box 3 and an anti-backflow component 4. An accommodating cavity 11 is provided inside the housing 1, and is configured to extend through the housing 1 along a length direction of the housing 1. The accommodating cavity 11 is provided with a first opening 12. The roller brush assembly 2 is arranged at the first opening 12 of the accommodating cavity 11. The roller brush assembly 2 is configured to rotate to drive debris in a pool into the accommodating cavity 11. The collection box 3 is slidably arranged in the accommodating cavity 11. The collection box 3 is configured to reciprocate along the length direction of the housing 1, such that the collection box 3 is accommodated within the accommodating cavity 11 or separated from the accommodating cavity 11. The collection box 3 is configured to collect the debris entering the accommodating cavity 11. The anti-backflow component 4 is arranged in the collection box 3, and is located on a side of the roller brush assembly 2 away from the first opening 12. The anti-backflow component 4 is configured to prevent the debris in the collection box 3 from escaping.

In the present disclosure, the accommodating cavity 11 is provided inside the housing 1 and extends through the housing 1 along the length direction of the housing 1. The collection box 3 is slidably connected to the accommodating cavity 11, and is configured to reciprocally slide along the length direction of the housing 1, such that the collection box 3 can be selectively accommodated in or separated from the accommodating cavity 11. In this way, convenient and rapid removal of the collection box 3 is achieved, thereby simplifying operation and improving the efficiency of debris and garbage cleaning.

In some embodiments, the accommodating cavity 11 is configured to extend downward from a middle portion of the housing 1 through a bottom of the housing 1.

Referring to FIGS. 1-5, the collection box 3 includes a box main body 31, a handle 32, a baffle 33 and a first snap-fit portion 34. The box main body 31 includes a bottom plate 311, a first side plate 312, a second side plate 313, and a third side plate 314. The first side plate 312, the second side plate 313, and the third side plate 314 are all provided on the bottom plate 311. he first side plate 312 and the second side plate 313 are respectively arranged on two sides of the bottom plate 311. The third side plate 314 is arranged between the first side plate 312 and the second side plate 313. The third side plate 314 is detachably connected to the bottom plate 311.

Two ends of the baffle 33 are connected to the first side plate 312 and the second side plate 313, respectively. The handle 32 and the first snap-fit portion 34 are provided on a side of the baffle 33 away from the first opening 12. The handle 32 is provided with a recess 321. The first snap-fit portion 34 is located above the recess 321. A gap is formed between the first snap-fit portion 34 and the recess 321, so as to provide space for elastic deformation of the first snap-fit portion 34. The handle 32 is configured to extend through the third side plate 314 and protrude outside the housing 1, thereby facilitating a user to pull out the collection box 3.

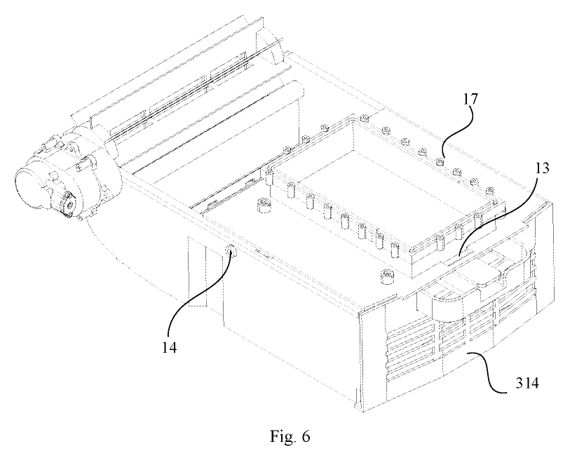

Referring to FIG. 6, the housing 1 is provided with a snap hole 13. The first snap-fit portion 34 is elastic, and is configured to elastically deform in a height direction of the housing 1, such that the first snap-fit portion 34 can abut against with or disengage from the snap hole 13, thereby fixing or releasing the collection box 3 relative to the housing 1. By providing the first snap-fit portion 34 and the snap hole 13, the stability of the collection box 3 during operation can be improved, preventing the collection box 3 from falling off.

In some embodiments, the snap hole 13 is located on a top wall of the accommodating cavity 11.

In some embodiments, the first snap-fit portion 34 is pressed downward, causing it to elastically bend and disengage from the snap hole 13. After disengagement, the first snap-fit portion 34 returns to its original shape, the handle 32 is pulled in a direction away from the first opening 12, until the collection box 3 is separated from the accommodating cavity 11. Thereafter, debris and garbage contained in the collection box 3 can be removed.

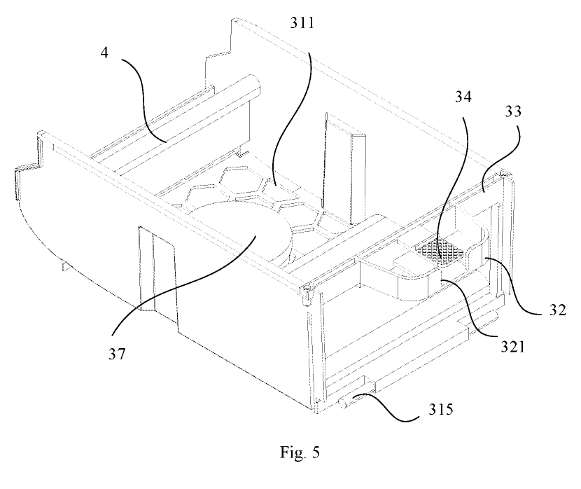

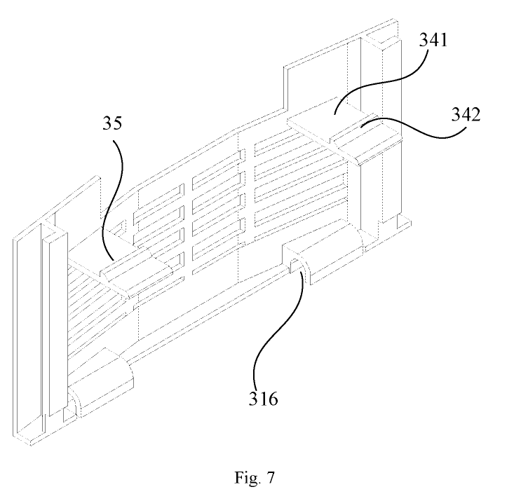

Referring to FIGS. 5-7, the collection box 3 further includes a second snap-fit portion 35. The box main body 31 further includes a rotating shaft 315. The rotating shaft 315 is connected to the bottom plate 311. A first side of the third side plate 314 is rotatably connected to the rotating shaft 315, and a second side of the third side plate 314 is connected to the second snap-fit portion 35. The second snap-fit portion 35 is elastic, and is configured to elastically deform in the height direction of the housing 1, such that the second snap-fit portion 35 can abut against or disengage from a side of the baffle 33 close to the first opening 12, thereby fixing or releasing the third side plate 314 relative to the bottom plate 311.

In some embodiments, the rotating shaft 315 is insertedly provided at an end of the bottom plate 311 away from the anti-backflow component 4. Two ends of the rotating shaft 315 are configured to protrude out of the bottom plate 311. Two ends on the same side of the third side plate 314 are sleeved over the two ends of the rotating shaft 315. Two ends of the third side plate 314 are each provided with a semicircular opening 316. When the third side plate 314 is released from the housing 1, the third side plate 314 is movably connected to the bottom plate 311, and is configured to rotate about the rotating shaft 315. By means of the semicircular opening 316, the third side plate 314 can be separated from the rotating shaft 315. Therefore, the semicircular opening 316 facilitate direct removal of the third side plate 314, achieving separation from the rotating shaft 315.

In this embodiment, the number of the second snap-fit portion 35 is two. Two second snap-fit portions 35 are arranged spaced apart from each other at an upper portion of the third side plate 314.

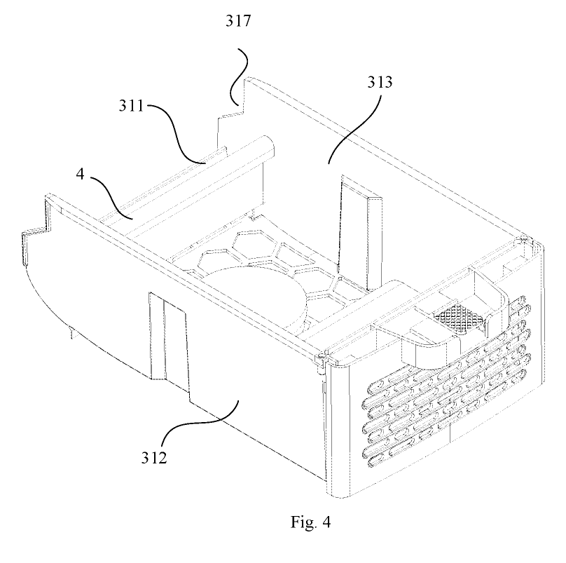

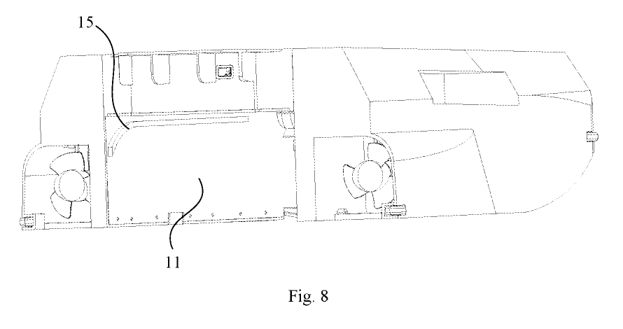

Referring to FIGS. 4, 6, and 8, the collection box 3 further includes a slider 14. The number of the slider 14 is at least two. Two sliders 14 are respectively provided on the first side plate 312 and the second side plate 313. Two inner side walls of the accommodating cavity 11 are each provided with a sliding rail 15. The slider 14 is slidably connected to the sliding rail 15 to drive the collection box 3 to move along the length direction of the housing 1. By slidably connecting the slider 14 to the sliding rail 15 and pushing the handle 32 toward the first opening 12, the first snap-fit portion 34 is caused to bend downward by the top wall of the accommodating cavity 11 and the force applied by the user. After the first snap-fit portion 34 is engaged with the snap hole 13 and returns to its original shape, the collection box 3 is assembled with the accommodating cavity 11.

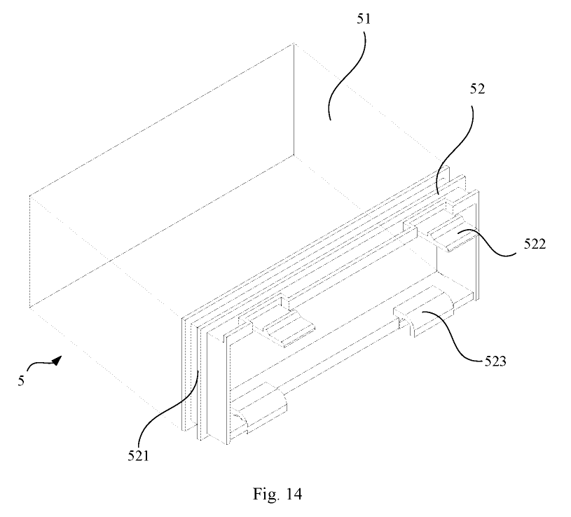

Referring to FIG. 14, the water surface cleaning device further includes a collection bag 5. The collection bag 5 includes a bag body 51 and a connecting assembly 52. A first side of the connecting assembly 52 is connected to the bag body 51, and a second side of the connecting assembly 52 is detachably connected to the box main body 31. When the third side plate 314 is separated from the bottom plate 311, the collection bag 5 is connected to the box main body 31.

In some embodiments, the collection bag 5 is configured as a frame structure.

In some embodiments, the connecting assembly 52 includes a main frame 521, a third snap-fit portion 522 and an engaging portion 523. The main frame 521 is configured as an annular structure. The third snap-fit portion 522 and the engaging portion 523 are provided on the same side of the main frame 521. The third snap-fit portion 522 is provided on a top surface of the main frame 521. The engaging portion 523 is provided on a bottom surface of the main frame 521. The third snap-fit portion 522 is elastic, and is configured to be engaged with the baffle 33. The engaging portion 523 is configured to be engaged with the rotating shaft 315. The third snap-fit portion 522 cooperates with the engaging portion 523, such that the collection bag 5 is connected to the collection box 3, thereby increasing the storage capacity for debris.

In some embodiments, the number of the third snap-fit portion 522 is two. The number of the engaging portion 523 is two. The engaging portion 523 is configured as a semicircular opening 316 structure.

In some embodiments, the bag body 51 is configured as a hollow structure to filter water.

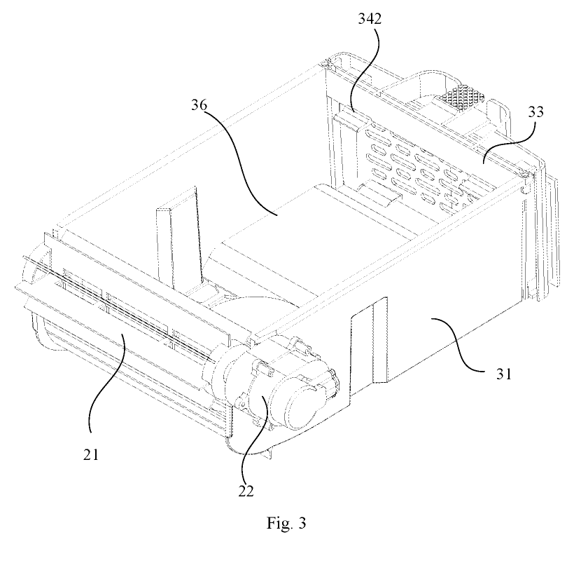

In some embodiments, referring to FIGS. 3, 6, 7 and 14, the first snap-fit portion 34, the second snap-fit portion 35, and the third snap-fit portion 522 have the same structure. Each of the first snap-fit portion 34, the second snap-fit portion 35 and the third snap-fit portion 522 includes a connecting portion 341 and a protruding portion 342. The protruding portion 342 is configured to protrude out of a top surface of the connecting portion 341. The connecting portion 341 of the first snap-fit portion 34 is connected to the baffle 33, and the protruding portion 342 of the first snap-fit portion 34 is configured to be inserted into the snap hole 13 and abut against an inner side wall of the snap hole 13. The connecting portion 341 of the second snap-fit portion 35 is connected to the third side plate 314, and the protruding portion 342 of the second snap-fit portion 35 is configured to abut against a side of the baffle 33 away from the first snap-fit portion 34. The connecting portion 341 of the third snap-fit portion 522 is connected to the main frame 521, and the protruding portion 342 of the third snap-fit portion 522 is configured to abut against the side of the baffle 33 away from the first snap-fit portion 34.

In some embodiments, the protruding portions 342 of the first snap-fit portion 34, the second snap-fit portion 35, and the third snap-fit portion 522 each have at least one inclined surface, so as to reduce resistance during snap fitting.

When it is necessary to increase the accommodating capacity, the collection box 3 is separated from the accommodating cavity 11, and the second snap-fit portion 35 is pressed downward, such that the second snap-fit portion 35 is bent downward and the third side plate 314 is caused to rotate rearward about the rotating shaft 315. Then, the third side plate 314 is pulled upward in an obliquely upward direction, such that the rotating shaft 315 is disengaged from the third side plate 314 at the semicircular opening 316, thereby completing removal of the third side plate 314. Subsequently, the engaging portion 523 is engaged with the rotating shaft 315, and the main frame 521 is rotated forward, such that the third snap-fit portion 522 is engaged with the baffle 33, thereby completing assembly of the collection bag 5 with the collection box 3.

When it is not necessary to increase the accommodating capacity, the collection bag 5 is removed by disengaging the third snap-fit portion 522 from the baffle 33 and disengaging the engaging portion 523 from the rotating shaft 315, thereby completing removal of the collection bag 5. Then, the semicircular opening 316 of the third side plate 314 is fitted onto the rotating shaft 315, and the third side plate 314 is rotated forward about the rotating shaft 315. Subsequently, the second snap-fit portion 35 is pushed to abut against the baffle 33, thereby completing assembly of the third side plate 314.

Referring to FIGS. 3-4, the collection box 3 further includes a first float. The bottom plate 311 is provided with a plurality of through holes. The collection box 3 further includes a first cavity 36, which is provided on the bottom plate 311. The first float is provided in the first cavity 36. When the water surface cleaning device collects debris and garbage, the collection box 3 becomes increasingly heavy, causing the water surface cleaning device to submerge. By providing the first cavity 36 and/or the first float, additional buoyancy can be provided to effectively offset part of the weight of the debris, thereby preventing excessive submersion of the water surface cleaning device.

In some embodiments, referring to FIGS. 3 and 5, the collection box 3 further includes a chemical storage container 37. The chemical storage container 37 is provided on the bottom plate 311, and is arranged spaced apart from the first cavity 36. The chemical storage container 37 is configured to accommodate chemicals for purifying and disinfecting the water in the pool.

In some embodiments, an end of each of the first side plate 312 and the second side plate 313 away from the third side plate 314 is provided with an avoidance notch 317 to avoid interference with the roller brush assembly 2. An end of the bottom plate 311 away from the third side plate 314 is configured as an upwardly arcuate shape.

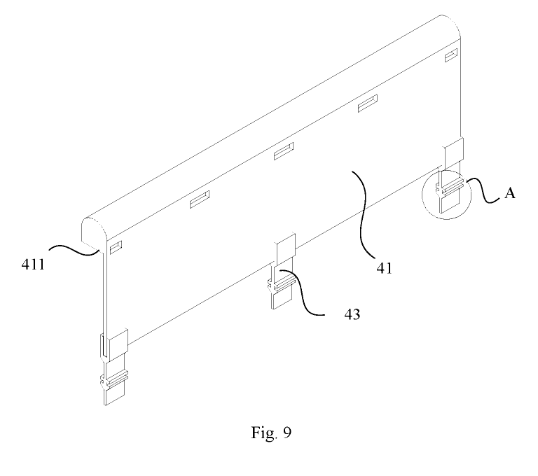

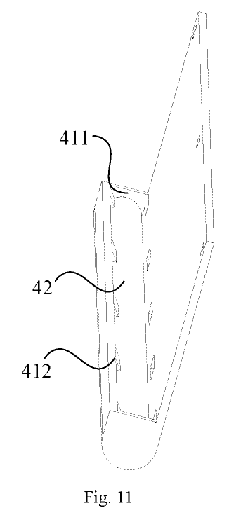

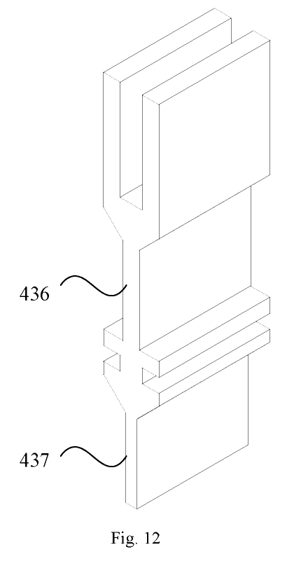

Referring to FIGS. 9-13, the anti-backflow component 4 is vertically arranged on the bottom plate 311. The bottom plate 311 is provided with an insertion hole 318. The anti-backflow component 4 includes a main body 41, a fixing structure 43, and a second float 42. The fixing structure 43 is made of a flexible material. A first end of the fixing structure 43 is connected to a bottom end of the main body 41, and a second end of the fixing structure 43 is insertedly provided in the insertion hole 318, thereby fixing the anti-backflow component 4 relative to the collection box 3. A top end of the main body 41 is provided with a second cavity 411. The second cavity 411 is formed by bending the top end of the main body 41 downward to define a semicircular structure, and is configured to extend through the main body 41 along a length direction of the main body 41. The second float 42 is provided in the second cavity 411, and is configured to fit the second cavity 411.

In some embodiments, the fixing structure 43 and the collection box 3 may be fixed by means of bonding or by other assembly structures.

In some embodiments, the main body 41 is made of a rigid material. The flexible material may be soft elastomer, silicone, rubber, or thermoplastic polyurethane (TPU).

In some embodiments, the main body 41 further includes a supporting portion 412. The supporting portion 412 is provided on a side wall of the second cavity 411, and is configured to support the second float 42. In some embodiments, a plurality of supporting portions 412 are provided. The plurality of supporting portions 412 are arranged spaced apart along an axial direction of the second cavity 411 on the side wall of the second cavity 411.

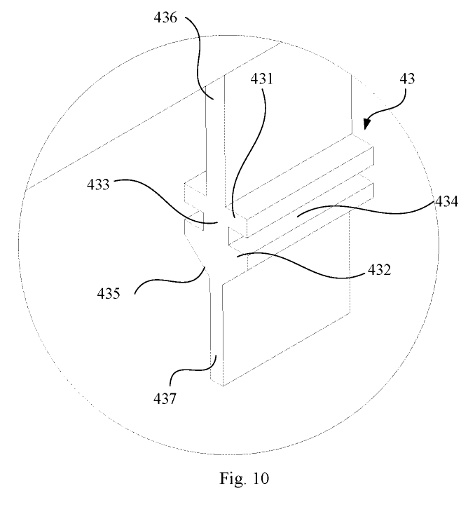

Referring to FIG. 10, the fixing structure 43 includes a first flange portion 431, a second flange portion 432, and a connecting portion 433. The first flange portion 431 is provided at the bottom end of the main body 41. The connecting portion 433 is provided between the first flange portion 431 and the second flange portion 432. The first flange portion 431 and the second flange portion 432 are both configured to protrude with respect to the connecting portion 433. A groove 434 is formed between the first flange portion 431, the connecting portion 433, and the second flange portion 432. The connecting portion 433 is configured to be embedded within the insertion hole 318. End faces of the first flange portion 431 and the second flange portion 432 respectively abut against corresponding end edges of the insertion hole 318 to limit vertical movement of the fixing structure 43 with respect to the insertion hole 318.

In some embodiments, the first flange portion 431 and the second flange portion 432 are respectively protrudingly provided on two side surfaces of the connecting portion 433 along a width direction of the fixing structure 43, such that grooves 434 are formed on the two side surfaces of the connecting portion 433 facing or away from the third side plate 314.

In some embodiments, the fixing structure 43 further includes a first guiding portion 435. The first guiding portion 435 is provided at a bottom end of the second flange portion 432. The first guiding portion 435 is integrally formed with the second flange portion 432. A width of the first guiding portion 435 is configured to decrease from an end connected to the second flange portion 432 to an end away from the second flange portion 432, so as to facilitate insertion into the insertion hole 318.

In this embodiment, cross sections of the first flange portion 431 and the second flange portion 432 are rectangular, and a cross section of the first guiding portion 435 is trapezoidal.

Referring to FIGS. 10-12, the fixing structure 43 further includes a first extension portion 436. A first end of the first extension portion 436 is connected to the bottom end of the main body 41, and a second end of the first extension portion 436 is connected to the first flange portion 431. By providing the first extension portion 436, a distance between the fixing structure 43 and the main body 41 is increased, thereby enhancing the bending of the main body 41.

In some embodiments, a width of the connecting portion 433 is greater than that of the first extension portion 436. Widths of the first flange portion 431 and the second flange portion 432 are equal and greater than the width of the connecting portion 433.

The fixing structure 43 further includes a second extension portion 437, which is provided at a bottom end of the first guiding portion 435. By providing the second extension portion 437, a user is facilitated in applying force to insert the connecting portion 433 into the insertion hole 318.

In some embodiments, the fixing structure 43 is fixed to the bottom end of the main body 41 by an overmolding method. In some embodiments, the fixing structure 43 may alternatively be fixed by means of bonding or assembly.

A plurality of the fixing structures 43 and a plurality of the insertion holes 318 are provided. The plurality of insertion holes 318 are arranged spaced apart along the bottom plate 311. The plurality of fixing structures 43 are arranged spaced apart along the bottom end of the main body 41.

A buoyancy of the second float 42 is greater than or equal to a combined weight of the main body 41 and the fixing structure 43.

When the water surface cleaning device operates, water enters through the first opening 12 and impacts the anti-backflow component 4. By virtue of flexibility of the fixing structure 43, the anti-backflow component 4 is forced to tilt in a direction away from the first opening 12, such that debris and garbage are carried by water flow to enter the collection box 3. When the water surface cleaning device is out of operation, the anti-backflow component 4 is allowed to float in water under the buoyancy provided by the second float 42, returning to a substantially vertical orientation, thereby preventing debris from escaping from the collection box 3.

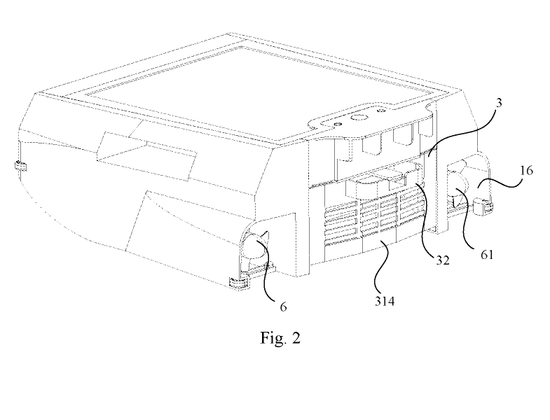

Referring to FIGS. 1-2, the water surface cleaning device of the present disclosure further includes a driving assembly 6. The driving assembly 6 is provided at an end of the housing 1 away from the first opening 12, and is configured to drive the housing 1 to travel.

The driving assembly 6 includes two propellers 61. Two sides of the housing 1 are respectively provided with a mounting cavity 16. The two propellers 61 are respectively provided within two mounting cavities 16. The two propellers 61 are configured to be driven to rotate, so as to drive the housing 1 to travel.

In some embodiments, the driving assembly 6 further includes a propeller motor. The propeller motor is connected to the two propellers 61 to drive the two propellers 61 to rotate. The propeller motor is capable of rotating in both forward and reverse directions.

In some embodiments, an end of each mounting cavity 16 away from the first opening 12 is through-open. A bottom of each of each mounting cavity 16 is through-open.

The water surface cleaning device of the present disclosure further includes a radar 62 or an infrared sensor. The radar 62 is provided at an end of the housing 1 adjacent to the first opening 12. The radar 62 is configured to detect obstacles. When an obstacle is detected, a rotation direction of the propeller motor is changed in response to signal feedback from the radar 62, such that the propeller motor is switched from forward rotation to reverse rotation.

In some embodiments, the number of the radar 62 is two. Two radars 62 are symmetrically arranged with respect to the first opening 12.

Referring to FIGS. 1 and 3, the roller brush assembly 2 includes a roller brush 21 and a driving part 22. The roller brush 21 is provided at the first opening 12, and the driving part 22 is provided inside the housing 1. The driving part 22 is connected to the roller brush 21. The driving part 22 is configured to rotate about its own axis, thereby driving the roller brush 21 to rotate.

The water surface cleaning device further includes a battery, a circuit board, a Bluetooth module and a sensor. A control cavity 17 is provided inside the housing 1, and is located above the accommodating cavity 11. The battery, the circuit board, and the Bluetooth module are provided within the control cavity 17. The battery is electrically connected to the driving part 22 and the propeller motor, respectively, so as to supply power to the driving part 22 and the propellers 61. The circuit board is communicatively connected to the driving part 22 and the propeller motor, respectively, and is configured to control start and stop of the driving part 22 and the propeller motor. The circuit board is further configured to adjust rotational speeds of the driving part 22 and the propeller motor, and to switch the propeller motor between forward rotation and reverse rotation. The Bluetooth module is configured to receive Bluetooth signals from a mobile phone, such that the water surface cleaning device is controlled via the mobile phone. The sensor is provided on a top wall of the accommodating cavity 11, and is configured to detect the debris level within the accommodating cavity 11, and to generate an alarm signal when the accommodating cavity 11 is in a filled state.

In some embodiments, the control cavity 17 is configured as a sealed chamber.

In some embodiments, the water surface cleaning device further includes a switch 63 and an indicator light 64. Both the switch 63 and the indicator light 64 are provided on a top surface of the housing 1. The switch 63 is electrically connected to the circuit board, thereby enabling control of the water surface cleaning device via the switch 63.

The water surface cleaning device further includes a solar panel 65. The solar panel 65 is provided on the top surface of the housing 1, and is electrically connected to the battery to supply power to the battery. In some embodiments, a side of the housing 1 away from the first opening 12 is provided with a charging port. The charging port is located above the collection box 3.

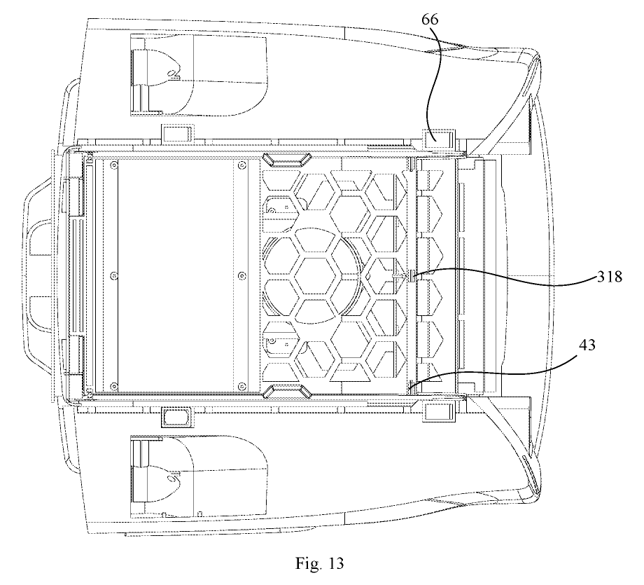

Referring to FIG. 13, the water surface cleaning device further includes an anti-grounding member 66, which is provided at the bottom of the housing 1. An elastic member is arranged inside the anti-grounding member 66, such that the anti-grounding member 66 is allowed to move freely up and down for height adjustment when pressed. The anti-grounding member 66 is configured to reduce a contact area of the bottom of the housing 1, thereby preventing the housing 1 from sticking to a bottom of the pool.

In this embodiment, the number of the anti-grounding member 66 is four.

Referring to FIG. 1, the water surface cleaning device further includes anti-collision rollers 67 and anti-collision strips. The anti-collision rollers 67 are arranged on two sides of the housing 1. The anti-collision strips are provided on the two sides of the housing 1.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An anti-backflow component for a water surface cleaning device, the water surface cleaning device comprising a collection box, and the anti-backflow component comprising:
a main body;
a fixing structure; and
a float;
wherein the fixing structure is made of a flexible material;
a first end of the fixing structure is connected to a bottom end of the main body, and a second end of the fixing structure is connected to the collection box, so as to fix the anti-backflow component relative to the collection box; and
the float is provided on the main body.

2. The anti-backflow component of claim 1, wherein a bottom surface of the collection box is provided with an insertion hole;
the fixing structure comprises a first flange portion, a second flange portion and a connecting portion;
the first flange portion is provided at the bottom end of the main body;
the connecting portion is provided between the first flange portion and the second flange portion;
the second flange portion is provided at a bottom end of the connecting portion;
the first flange portion and the second flange portion are both configured to protrude with respect to the connecting portion; and
the connecting portion is configured to be embedded within the insertion hole.

3. The anti-backflow component of claim 2, wherein the fixing structure further comprises a first extension portion; and
a first end of the first extension portion is connected to the bottom end of the main body, and a second end of the first extension portion is connected to the first flange portion.

4. The anti-backflow component of claim 3, wherein the fixing structure further comprises a first guiding portion;
the first guiding portion is provided at a bottom end of the second flange portion; and
a width of the first guiding portion is configured to decrease from an end connected to the second flange portion to an end away from the second flange portion.

5. The anti-backflow component of claim 4, wherein the fixing structure further comprises a second extension portion; and the second extension portion is provided at a bottom end of the first guiding portion.

6. The anti-backflow component of claim 1, wherein a plurality of fixing structures are provided; and the plurality of fixing structures are arranged spaced apart at the bottom end of the main body.
